(19) United States
(12) Patent Application Publication
(10) Pub. No.: US 2022/0212792 A1
(43) Pub. Date: Jul. 7, 2022

(54) High-Resolution Camera Network for Ai-Powered Machine Supervision

(71) Applicants: California Institute of Technology, Pasadena, CA (US); Toofon, Inc., Pasadena, CA (US)

(72) Inventors: Morteza Gharib, Altadena, CA (US); Michael V. Ol, Pasadena, CA (US); David Jeon, Pasadena, CA (US); Amir Emadi, Pasadena, CA (US)

(73) Assignees: California Institute of Technology, Pasadena, CA (US); Toofon, Inc., Pasadena, CA (US)

(21) Appl. No.: 17/647,337

(22) Filed: Jan. 6, 2022

Related U.S. Application Data
(60) Provisional application No. 63/134,905, filed on Jan. 7, 2021.

(51) Int. Cl. B64C 39/02; G06T 7/11; G05D 1/10

(52) U.S. Cl. CPC B64C 39/024; G06T 7/11; G05D 1/101; G06T 2207/20081; B64C 2201/127; G06T 2207/30252; G06T 2207/30241; B64C 2201/146; G06T 2207/20084

(57) ABSTRACT

A network of high-resolution cameras for monitoring and controlling a drone within a specific operational environment such that the latency time for communication between the cameras and drone is less than that of human controlled drones. The drone can communication drone health data to the network of cameras where such information can be combined with visual image data of the drone to determine the appropriate flight path of the drone within the operational environment. The drone can then subsequently be controlled by the network of cameras by maintaining a constant visual image and flight control data of the drone as it operates within the environment.

### CROSS-REFERENCE TO RELATED APPLICATIONS

This application claims priority to U.S. Provisional Patent Application No. 63/134,905 filed on Jan. 7, 2021, the disclosure of which is herein incorporated by reference in its entirety.

### FIELD OF THE INVENTION

This application generally refers to camera systems and networks of cameras systems. More specifically, the application relates to camera systems that can be used to supervise and control a drone or other device.

### BACKGROUND

The U.S. Federal Aviation Administration (FAA) has very stringent requirements for drone operations. These requirements generally require a Certificate of Airworthiness (COA) or an exemption in order to operate drones that operate beyond the line of sight of the operator. Additionally, the systems and methods that are used to obtain a COA or an exemption are time consuming and often require the signature authority of multiple individuals within a management hierarchy. Accordingly, most drone operations are restricted to line of sight operations. In other words, they must be done in such a manner that requires the pilot or suitable surrogate to maintain visual contact with the drone throughout the entire flight.

Line of sight limitations can present a number of issues in the ever-expanding use of drones. For example, some companies are looking to utilize drones for last mile delivery. Last mile deliver typically refers to the delivery of packages to the final destination. The final destination can be anywhere from a few hundred yards from the point of origin to several miles. Some of these limitations are related to the range of the drone. Since unassisted human visual acuity quickly degrades beyond a few hundred yards, visual line of sight becomes difficult to achieve. Accordingly, the FAA is reluctant to grant COA's and/or exemptions to operators even when other requirements under 14 CFR part 107 are met.

### SUMMARY OF THE INVENTION

Systems and methods for supervising and controlling a drone including:
a) Obtaining a network of high bandwidth cameras;
b) Obtaining at least a first drone for remote operation within the network of high bandwidth cameras;
c) Coordinating the communication between the network of high bandwidth cameras and the at least first drone, where the at least first drone has at least one transmitter and receiver connected thereto such that the at least one drone can transmit drone data to the network of high bandwidth cameras and wherein the at least one receiver can receive flight information communication from the network of high bandwidth cameras such that the received information can be used to alter or control a flight path of the at least one drone; and
d) Wherein at least one camera within the network of high bandwidth cameras has a visual connection with the at least one drone at any given time during flight operations of the at least one drone.

Many embodiments are directed to a mesh network for controlling drones where the network is made up of a plurality of cameras making up a plurality of nodes within a specific geographical region. Each of the plurality of nodes has at least one of the plurality of cameras in a fixed position within the geographical region. Each of the plurality of nodes are configured to monitor a portion of the geographical region such that the plurality of nodes are capable of capturing image data from the entire geographical region. Additionally, the network of cameras are configured to control at least one drone with a transponder unit, where the transponder unit can transmit drone data to any of the plurality of cameras. Each of the plurality of cameras is configured to receive the drone data and combine the drone data with a visual image of the drone within the geographical region to determine a correct flight path for the drone within the network of nodes; and wherein each of the plurality of cameras is configured to transmit a new set of flight control data to the drone such that the drone can alter course as needed based on the new set of flight control data, where the latency between the drone and any of the plurality of cameras is lower than the human latency times.

In other embodiments, each of the plurality of cameras is a 5G enabled camera.

In still other embodiments, each of the nodes contains at least one camera.

In yet other embodiments, each of the plurality of nodes contains more than one camera.

In still yet other embodiments, at least one of the more than one cameras is an infrared camera.

In other embodiments, the system has a supervisory control system wherein the drone data is transmitted from the network of nodes to the supervisory control system for monitor.

In still other embodiments, the supervisory control system is a human based system.

In yet other embodiments, the drone is a VTOL drone, a fixed wing drone, and/or a hybrid drone between fixed and rotary wing.

Other embodiments are directed to a method for controlling moveable assets within an operational environment that include the following steps:
Obtaining a drone for operational control within a specific environment;
Obtaining a network of cameras positioned within the specific environment such that the network of cameras is positioned to maintain a continuous visual image of the drone within the specific environment;
Transmitting a set of drone data to the network of cameras;
Combining the set of drone data and the continuous visual image of the drone to determine an appropriate flight path for the drone within the specific environment; and
Adjusting the appropriate flight path for the drone based on the combination of drone data and visual image of the drone.

In other embodiments, the specific environment is an urban environment.

In still other embodiments, the continuous visual image of the drone is maintained by overlapping areas of interest between each of the cameras within the network of cameras.

In yet other embodiments, adjusting the flight path for the drone includes altering the flight path to avoid an obstruction selected from a group consisting of weather, building, construction, emergencies, and traffic.

In still yet other embodiments, the systems and methods include more than one drone.

In other embodiments, the drone(s) have a transponder for communication with and between the network of cameras.

Additional embodiments and features are set forth in part in the description that follows, and in part will become apparent to those skilled in the art upon examination of the specification or may be learned by the practice of the disclosure. A further understanding of the nature and advantages of the present disclosure may be realized by reference to the remaining portions of the specification and the drawings, which forms a part of this disclosure.

### BRIEF DESCRIPTION OF THE DRAWINGS

The description will be more fully understood with reference to the following figures, which are presented as exemplary embodiments of the invention and should not be construed as a complete recitation of the scope of the invention, wherein:

FIG. 1 is a graphical illustration of a communication network in accordance with embodiments.

FIG. 2 illustrates an operational environment of a drone in accordance with embodiments.

FIG. 3 illustrates an exemplary embodiment of a camera system for controlling drones.

FIG. 4 illustrates a sequence diagram for drone control based on networked cameras in accordance with embodiments.

FIG. 5 illustrates a process of drone control in accordance with embodiments.

FIG. 6 illustrates a process of drone monitoring and control in accordance with embodiments.

### DETAILED DESCRIPTION OF THE INVENTION

Turning now to the drawings, systems and methods for controlling drones based on a network of wireless cameras is illustrated. Many embodiments are directed to a network of cameras positioned at various locations within a desired operational environment. Each of the cameras are positioned at desired node locations and are configured to communicate with one or more drones within the operational environment. Each of the cameras are configured to obtain visual data of the drone and the drone's flight path. The cameras visual data can be used to confirm and/or improve the drone's location tracking. This can be especially helpful in areas where GPS positioning can be unreliable, such as urban environments. Accordingly, the network of cameras can help provide a true position of the drone in all environments. Additionally, each of the cameras within the operational environment are in communication with a transponder on each of the drones. The transponder transmits drone flight data to the cameras by which the cameras can then provide updated drone control information to the drones to ensure the drone(s) operate safely within the operational environment.

Urban cargo delivery systems are often referred to as “last mile” delivery systems. As previously discussed, such systems can operate anywhere from a few hundred yards to several miles to deliver goods and/or services to a desired location or customer. More and more companies are considering the use of drones to operate within the “last mile” delivery system due to their improved capabilities and distance. However, as previously discussed, the current governmental system that regulates the use of drones presents various obstacles by which potential users cannot operate efficiently. For example, the current 14 CFR part 107 requires that drone operators maintain a line of sight with the drone in order to safely operate and control the drone. This requirement can greatly reduce the operational area of a drone for “last mile” delivery systems. This is even with a drone that meets the requirements for air worthiness under part 107 and is configured to operate under the 400 foot above-ground-level (AGL) altitude.

The line of sight requirement combined with the lengthy and arduous process of obtaining permits to operate drones, can present various obstacles for the future of logistics chains and support. In response, the present disclosure proposes a system and method for drone control that maintains line of sight with a drone by way of a network of high frame rate, high definition, low latency and high transmission rate capable cameras. The efficient cameras work in conjunction with additional sensors positioned on or within the drones to continuously monitor the drone during flight. The continuous monitoring by way of the cameras and other sensors can allow the system to continuously maintain a visual line of sight with the drone and adjust the drone's functions as necessary to maintain safe and effective flight operations. The high definition network of cameras can enable higher performance and faster response time than a human operator. Additionally, human operators can serve a supervisory roll in monitoring the camera feed and drone data from a remote location and adjust as needed. However, many embodiments of the system are configured to operate with little feedback from the human due to the increased response time that humans typically have.

### Embodiments of the System

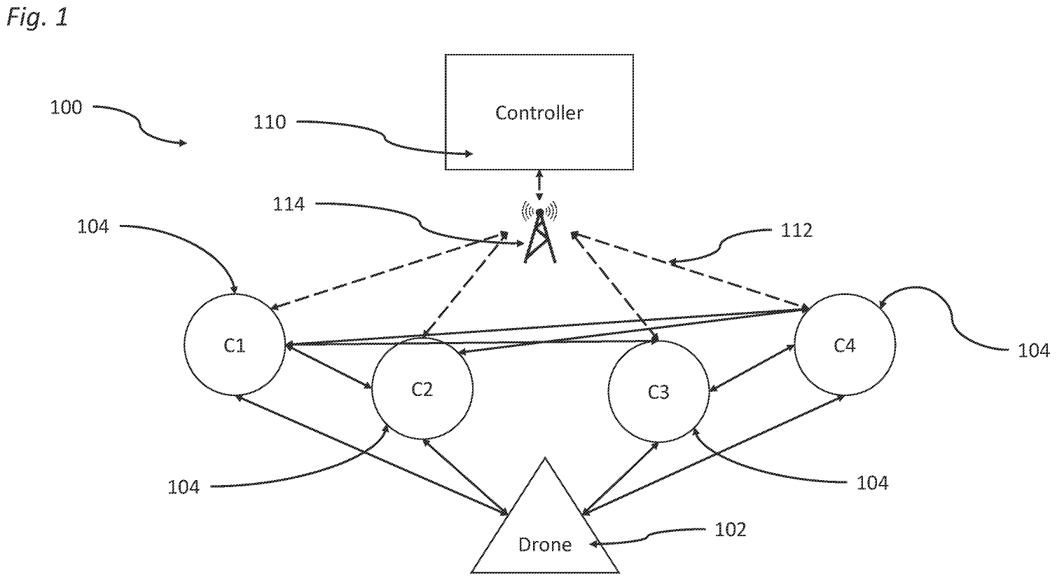

In accordance with many embodiments, drones can be operated with an artificial intelligence pilot that is enabled by a network of high-resolution cameras. For example, FIG. 1 illustrates a network system 100 that can be configured to control one or more drones 102 within an operational environment such as a last mile delivery. The network 100 can have a number of different high-resolution cameras 104 that are positioned at different locations within the operational environment. In some embodiments, the operational environment can be an urban setting where the cameras are positioned on buildings or other fixed structures such that each of the cameras is positioned to cover a particular area of the operational environment. The cameras 104 can be configured to communicate with the drone 102 by way of a transponder located on the drone 102. The drone transponder can send drone information, including flight path data, drone operational data such as battery life and function of propellers to the cameras. Accordingly, the cameras 104 can then coordinate visual data with the transponder data to modify, if necessary, drone flight instructions to operate the drone to the desired destination.

As can be appreciated, the system 100 can be augmented by a remote supervisor 110. The remote supervisor can be a human operator that views the data transmitted 112 from the network of cameras 104 through a wireless transmission tower or system 114. The wireless transmission tower 114 can be a single tower or a network of towers that can communicate with a controller 110. The controller 116 can be a number of different configurations such as a human supervisor or operator that can send and receive signals to and from the network of cameras 104 and drones 102.

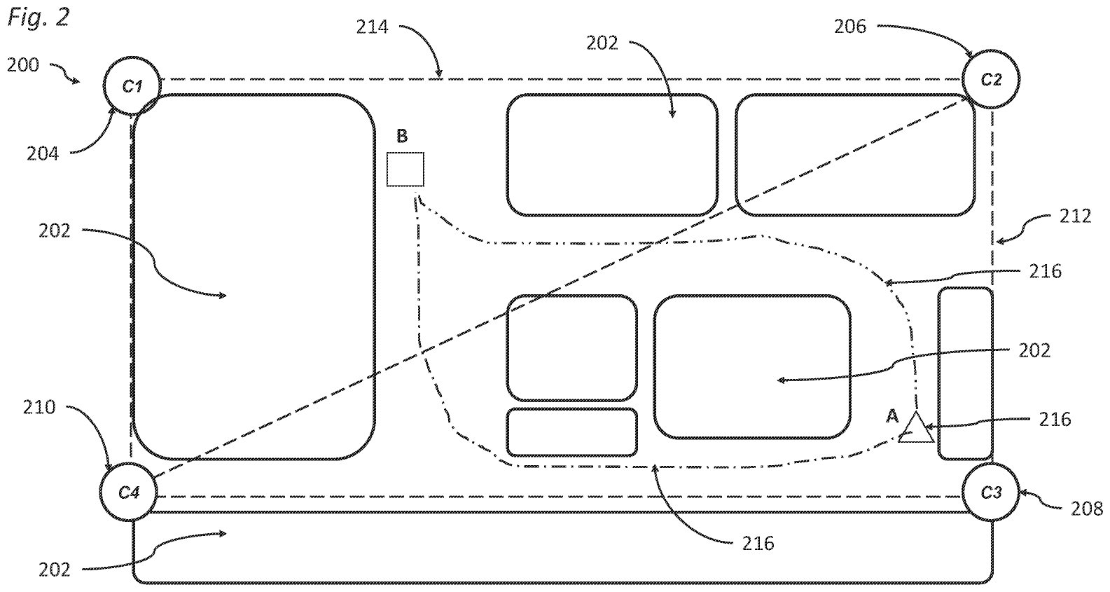

A more practical application illustration of an operational environment can be further illustrated in FIG. 2. The layout in FIG. 2 illustrates a plan view of a section of an urban environment with a number of different buildings 202. On one or more buildings, cameras (204-210) can be positioned such that each camera is configured to visually monitor a portion of the operational environment 200. As such the operational environment can be separated into multiple zones (212 and 214). Although two zones are illustrated, it can be appreciated that an operational environment can have more than two zones for which a drone 216 can operate, so long as each zone has a sufficient number of cameras to visually cover the zone for control of the drone. In some embodiments, the cameras (204-210) can have overlapping areas of interest such that the combination of images from the cameras cover an entire zone or multiple zones.

In accordance with various embodiments, a drone 216 can have a flight path (218, 220) that is designated to travel from a location “A” in zone 1 and end at location “B” in zone 2. The drone can be provided with one or more flight paths (218, 220) from which it can operate. Additionally, in some embodiments the drone 216, in coordination with the network of cameras can adjust the flight path based on changing conditions such as weather, construction, traffic, emergencies such as fires in the flight path etc.

As can be appreciated, the network of cameras can communication with each other (also illustrated in FIG. 1) in order to maintain constant visual contact with the drone such that at any given time the drone 216 is continually seen by at least one camera. In accordance with many embodiments, the network of cameras can be represented by one or more cameras at each node (204-210) which can help to strengthen the mesh network of cameras. Additionally, the drone 216 can have an internal transponder to communicate with each of the camera nodes (204-210) in the network to provide drone health data to the network. This information can be transmitted between all of the cameras in the network and in each zone such that the network of cameras can adjust the flight controls of the drone to ensure a safe operation. Furthermore, the network of cameras and associated zones can be expanded to cover entire urban areas or other geographical locations such as suburban areas. Additionally, it can be appreciated that some embodiments may be optimized for a mobile network of cameras. For example, although not illustrated, the nodes can be fixed to drones that are mobile and can be operated over a remote environment such as a forest region. A mobile network of cameras can then be used to create a virtual operational environment in which a delivery drone could be used to deliver a number of different items such as medical supplies or equipment to operators working in the remote environment. This can have a wide variety of applications, including military, medical, search and rescue, as well as fire fighting applications.

In accordance with many embodiments, the transponder communication between the drones and the cameras can be continuous such that any adjustments to the drone flight can be altered as needed. For example, some systems can be programmed to monitor various fault codes and/or data from the transponders and/or the cameras. Such codes and data could include one or more rotor failures, dramatic reduction in battery power, drift beyond predefined flight path, abnormal oscillations in the drone, rotor speed and temperature, and/or a unique ID number for the drone. The unique ID number can be similar to that of a tail number on a traditional aircraft that allows for that particular drone or moving asset to be identified as authorized to operate within the network of cameras. Additionally, drones can be configured with additional sensors that help monitor weather and the surrounding environment to notify the camera/control system when things have changed. These can include additional cameras that can work in conjunction with the transponder and the network of cameras to identify obstacles and navigate the operational environment. This can be highly beneficial because a high density of cameras or nodes can serve to help reroute the drone to avoid unforeseen problems. Furthermore, a dense network of nodes can be used to redirect drones in the event of a cancellation of a cargo delivery order. For example, in some embodiments the drone can be redirected between mesh networks and can be directed to a new supply depot and/or new delivery location.

The mesh network of nodes, illustrated in many embodiments, can represent what the FAA refers to as a “dedicated airspace”, which creates a type of local host model for flight operations. As can be appreciated, this type of model can be applied in any number of situations and in any number of locations such that FAA regulations can be met and still maintain a secure airspace. The secure airspace can be managed by the cameras and their ability to quickly identify the movement of any assets within the area. For example, much like traditional aircraft have identifying information that is transmitted to air traffic controllers, the network of cameras can be configured to receive similar transponder data from any moving asset in the area. If the moving asset is not identified as one that is authorized within the area, the cameras can be used to identify and control the unknown object and prevent undesired safety incidents. Likewise, the mesh network of nodes also addresses potential cyber security concerns that come with connections to the cloud by having a closed network for drone flight operations. By addressing potential security issues and creating a defined geographically dedicated airspace for drone operations can allow for FAA exemption approvals where they normally would not, such as night operations.

As briefly described above, the network of cameras can act as an artificial intelligence (AI) control system to help control moving assets within an operational area. In accordance with many embodiments, the AI system of cameras and/or node can act to control assets by combining camera image data, generated from maintaining a continual visual image of the moving assets and/or operational environment, with transponder data from the moving asset. The combined data can be used to identify what asset is moving in the area such as a drone or otherwise as well as identify any obstacles that could negatively affect the movement of the assets within the operational environment. This can serve as an AI control system for the moving assets because it can constantly be transmitting and receiving information that can be used to control the movement of the assets within the operational environment. An AI control system can be far faster and more efficient than humans. For example, a reasonable estimate for human response time in drone control is roughly 200 ms. This includes the time for the image to travel to the brain and the brain to process the image into action. In contrast an AI type control system, such as described in the embodiments herein, can combine high-definition camera image data with drone transponder data (relatively low in terms of data transfer times and size) within the 10 ms range or faster. This can result in a much faster response time to control drones within the network. Accordingly, the AI control of moveable assets within a network of cameras can offer improved systems for deliverables that would otherwise be unattainable with human control. In accordance with many embodiments, each camera can be configured with an internal processing system that can act as an internal AI. This internal system can help to improve or reduce latency of the data being transmitted between the drone and the camera(s). Some embodiments may have external computers or processors that serve as an additional AI unit to augment other computers or processors. The external computer can be located in local 5G towers such that they can operate to cover one or more cameras covering a particular area.

In accordance with many embodiments, the drone(s) can operate autonomously or semi-autonomously but still be machine supervised by the use of the network of cameras. The supervision of the drone movement can be handed off from one node of cameras to the next node to maintain constant visual contact with the drone. Additionally, the transponder data can be transmitted to one or more nodes within range to ensure a constant connection and analysis of the drone state within the network. Consequently, the network of cameras can identify and analyze the transponder data to direct and redirect the drone within the network. Additionally, with the low latency 5G network connection that numerous embodiments can have, it can be appreciated that the AI control system can operate continuously without the need for rest. Cameras can switch between operational modes and the nodes can have redundant cameras for continuous operation. This can be highly beneficial in aiding and maintaining supply chain networks that currently rely on human intervention. Systems described herein can operate beyond the capabilities of humans, thus allowing for better coverage in the supply chain as well as reduced risk.

### Embodiments of Cameras and Drones

In accordance with many embodiments, the drones used within the system can be any type of suitable drone for flight. For example, the drone can have a number of rotors and can be configured for Vertical Take Off and Landing (VTOL). Other drones can be fixed wing drones. Still other drones can be a hybrid between fixed and rotary wing drone. It should be well understood that many embodiments of the drones will be configured to meet FAA regulations for flight worthiness as well as be capable of communication with any number of systems for operational control. The drones, in accordance with numerous embodiments can be configured to house one or more transponders. The transponders, as previously described can be used to transmit drone vehicle data to the network of cameras which can then utilize the transponder data in combination with camera image data to direct or control the flight of the drone. The transponder can be any type of transponder that allows the drone to communicate continuously with one or more of the networked cameras.

The cameras that can be used in accordance with various embodiments should be high resolution cameras such that they are capable of producing high quality images similar to the human eye. Given the large amount of data can be generated through high resolution images, it can be appreciated that many embodiments of cameras are configured to be high bandwidth capable as well as have the ability to rapidly transmit data with little latency. As such, some embodiments of the cameras can be enabled with 5G capabilities. 5G wireless networks operate by sending signals directly between towers in sequence rather than bouncing signals to and from a remote hub, such as a geosynchronous satellite. This means speed of signal travel is much higher than older wireless systems and can match hardline systems like fiber networks. The 5G and any future generations of wireless network technology would be preferred for the system because of the speed at which such technology can transfer data. This presents the added benefit and augmentation to the system of cameras because of the large amount of data that high resolution images can generate and a 5G enabled network of cameras can offer low latency transfer times that offer a faster and more improved response time over human controlled devices A 5G network and beyond can be capable of transmitting such data rapidly between cameras and/or moving assets to allow for real time control of a moving asset. The 5G wireless network is only expected to improve over time, which would only improve the capabilities of the various embodiments described herein.

As can be appreciated, any number of cameras can be used within the system that are high resolution and configured with 5G or higher capabilities. Some embodiments, the cameras can produce 4K videos at a rate of 1 gigabit per second (Gbs) or higher. Additionally, the frame rate of the cameras can be upwards of 100 frames/second or higher. Some embodiments of cameras can be configured with infrared capabilities. Other embodiments can include cameras with additional sensors such as LED's or Spectral imaging capabilities. It should be understood that cameras can also be updated with improved imaging technology to allow for improved data capture for overall operational control. Accordingly, various embodiments of the system described above can utilize one or more types of cameras at the various nodes to produce multiple image types of the drones to be combined with the transponder data of the drone to control the movement of the drone within the network in a number of different flight conditions.

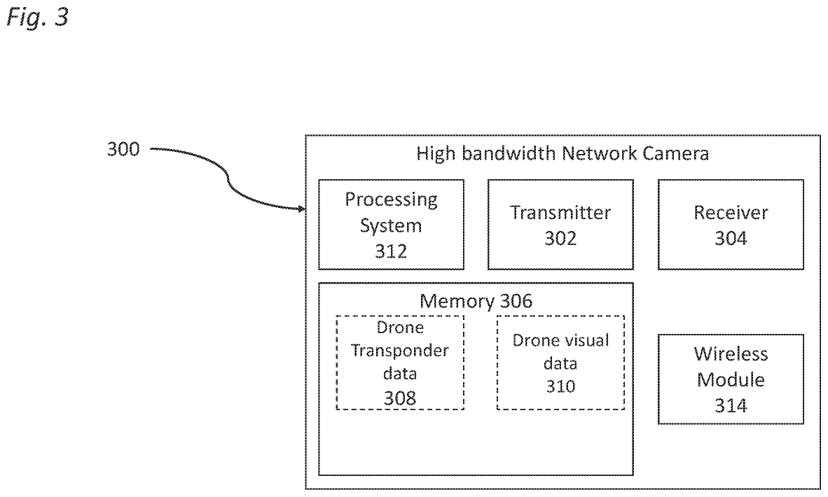

As can be appreciated, many embodiments of the system can be configured to use any number and type of cameras and/or drones and transponders such that the overall control of the moveable asset is continually maintained. FIG. 3 illustrates an embodiment of a camera that can be used within the network. The camera 300 can be a high bandwidth camera that has both a transmitter 302 for communication to the drone and a receiver 304 for communication from the drone and/or a supervisor. Additionally, the camera 300 can be configured with a memory system 306 for storing drone transponder data (308) and visual data (310) that can be processed by an internal processing system 312. The internal processing system 312 can then be used to combine the transponder and visual data to determine if the drone is on the correct flight path. As can be appreciated, numerous embodiments can be configured with a wireless module 314 that can improve communication between the camera 300 and other elements of the system such as the drone and/or supervisor. This can be a cellular module such as 5G or any other suitable module. With development of more high-speed cameras and expansion beyond 5G networks, many embodiments may be configured to utilize and/or be upgraded with improved technology to improve the overall response time and control of drones within the network of cameras.

In some embodiments, the camera system 300 could be configured with a processor 312 that functions much like a powerful computer that can help to increase the range and capabilities of camera for processing image and transponder data. With the increasing prevalence of smaller processing systems seen in phones and cameras, it is reasonable to see how many embodiments of the camera 300 could function similar to that of a small laptop or cellular phone. This improved processing power combined with 5G and beyond capabilities can allow the cameras to be extremely efficient at processing data. Furthermore, the low latency 5G connection can also allow for the camera to be connected to a remote server that is much larger and capable of storing and managing larger amounts of data that can be used for future operations such that the system overall can continually be learning from each subsequent operation.

Although the term drone is used throughout, it should be appreciated that drones, in accordance with many embodiments, can vary in terms of their capabilities and functions. Essentially, many embodiments may define the drone to be a moving asset which could be any number of moving objects within the operational environment. For example, some embodiments may have unmanned aerial vehicles such as copters (tri, quad, etc.) fixed winged aircraft, hybrid aircraft. Other embodiments of drones may be wheeled vehicles that may be manned or unmanned. In manned embodiments, the network can be configured to communicate directly with the vehicle as described above, while offering a human interaction as a redundant control system if necessary. Accordingly, it should be understood that the term “drone” or “drones” can take on any reasonable meaning in terms of movable assets within the operational environment or ones that might come into the operational environment.

### Embodiments of the System Operation

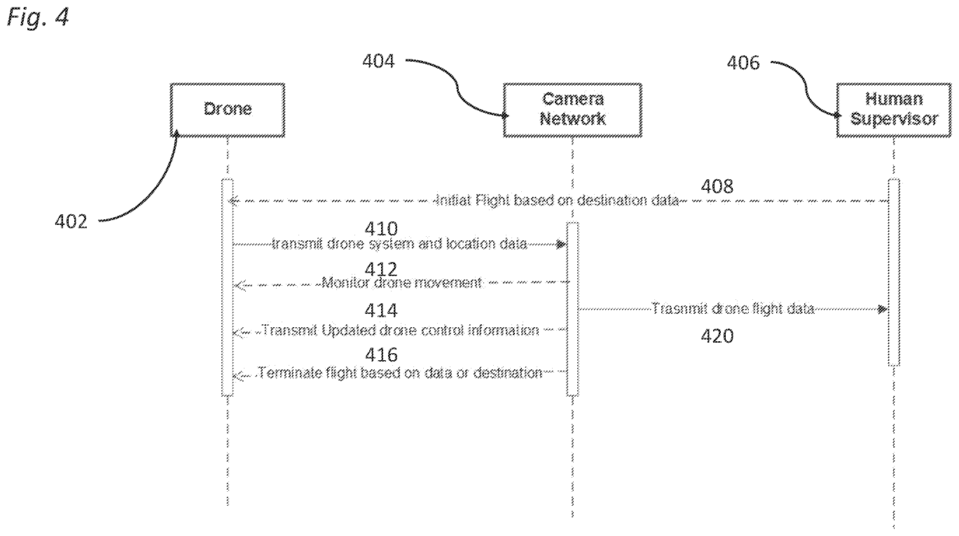

Referring now to FIGS. 3 through 6 the system described above can be configured to operate in a number of ways to ultimately control a drone through machine supervision. For example, FIG. 4 illustrates a communication between the drone 402, the camera network 404, and a human supervisor 406. In many embodiments the drone 402 can be request and/or receive initial flight information data (408) from the human supervisor 406. In other words, the supervisor 406 can send data (408) to the drone 402 indicating the location and time for the drone to deliver goods. As such the drone 402 can then initiate flight based on the data received from the supervisor 406. Once in flight, the drone 402 can then communicate with the camera network 402 by a continuous transmission of drone system data (410) by way of the transponder. The camera network 404, as described above can maintain a constant visual contact (412) with the drone 402 as it flies within the network. As flight data is transmitted (410) to the network of cameras and combined with the visual camera data, new drone control information can be transmitted to the drone (414). Additionally, if the network and/or supervisor, believes the flight is either complete or should be terminated, then the network of cameras 404 can transmit a termination flight sequence (416) to the drone 402, subsequently ending the flight. As can be appreciated, there can be any number of transmissions between the drone 402 and the network of cameras 404 throughout the flight as the drone 402 can be configured to fly for extended periods of time and through any number of environments. Additionally, numerous embodiments may include transmission lines between the camera network 404 and the supervisor 406 where the camera network 404 is transmitting drone data (420) to the supervisor. This allows for a redundant supervisory control in which the human can then terminate the flight if needed.

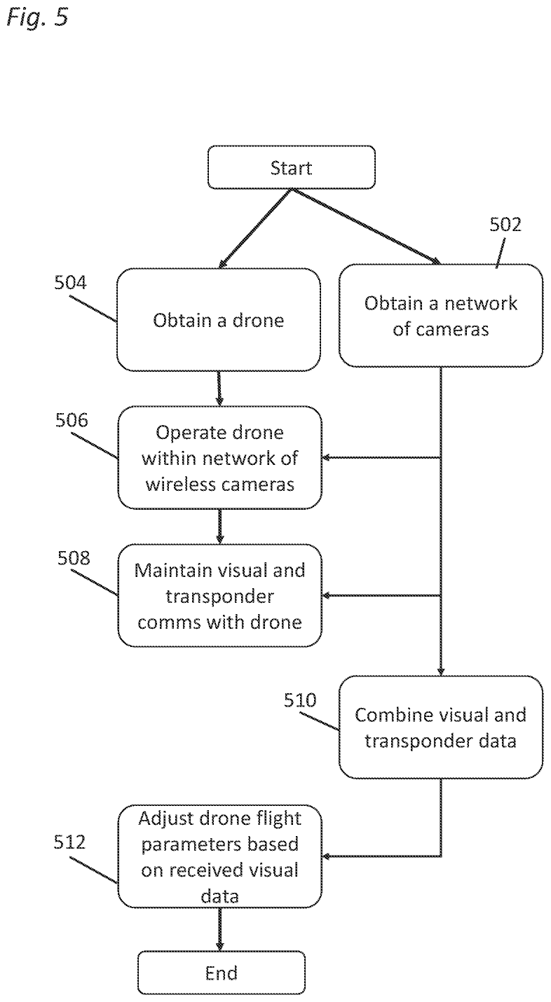

FIG. 5 illustrates an embodiment of a process model of drone operation within a mesh network of cameras. In various embodiments, mesh network of cameras is established in a particular geographical location (502) Additionally, a drone capable of operating in the mesh network is configured or obtained (504). The drone receives signals from a supervisor and/or the mesh network to initiate and/or maintain operation within the network (506). The network of cameras then maintains a visual and transponder connection between the drone as it operates within the network (508). The the network of cameras is configured to process the visual and transponder data in a combined method (510) from which it can send updated flight control parameters to the drone (512). This can continue in a loop fashion until the drone has reached its desired location or suffers a failure that would require a flight termination.

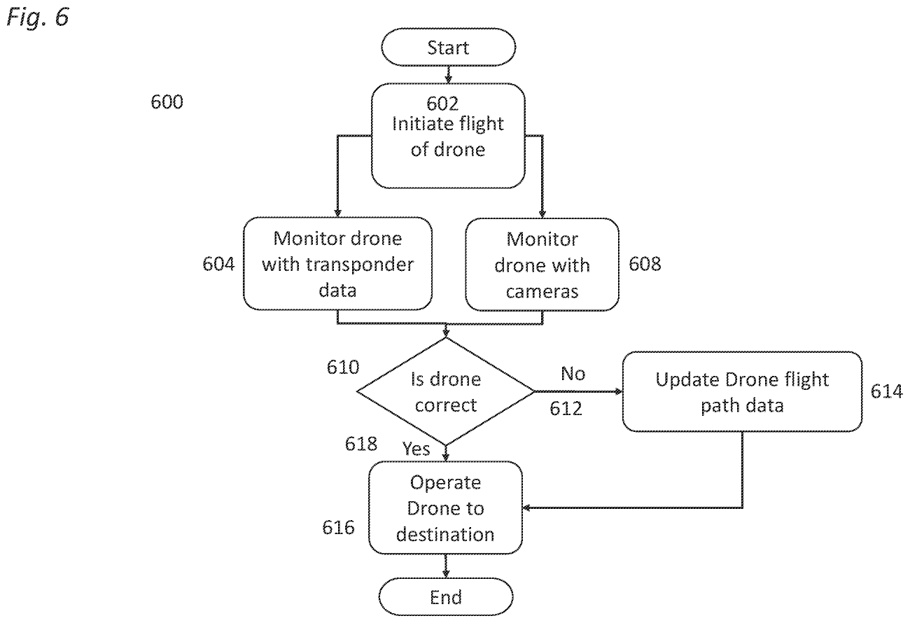

Likewise, FIG. 6 illustrates an embodiment of a drone control process 600 in which the network of cameras may evaluate the drone data to better control the flight of the drone. For example, the network of cameras and/or supervisor can initiate drone flight (602). Once in flight and the drone is moving towards its intended target the drone can communicate with the camera network continuously. For example, the camera network can continuously monitor the drone transponder data (604) as the drone moved between the nodes. Additionally, each node can then capture image data of the drone flight (608) as the drone moves along its intended flight path. The data can then be evaluated to determine if the drone health is good or if the drone is still on the correct path (610). If the processed data indicates an error (612) then the network of cameras can update the drone flight path data (614). This can include altering the position of the drone to avoid traffic or bad weather or construction. Additionally, it can include the change in rotor speed to adjust for flight errors or impending problems due to flight path interruptions. Ultimately, the drone can be controlled such that it reaches the desired destination (616); keeping in mind that the desired destination can be to terminate the flight due to unsafe drone operation. Furthermore, if the processing of the data indicates that the drone is on the correct path (618) the drone can be directed to continue on to the final destination as well (616) such as for delivery of a good.

### DOCTRINE OF EQUIVALENTS

This description of the invention has been presented for the purposes of illustration and description. It is not intended to be exhaustive or to limit the invention to the precise form described, and many modifications and variations are possible in light of the teaching above. The embodiments were chosen and described in order to best explain the principles of the invention and its practical applications. This description will enable others skilled in the art to best utilize and practice the invention in various embodiments and with various modifications as are suited to a particular use. The scope of the invention is defined by the following claims.

What is claimed is:

1. A mesh network for controlling drones comprising:
a plurality of cameras making up a plurality of nodes within a specific geographical region, each of the plurality of nodes having at least one of the plurality of cameras in a fixed position within the geographical region, wherein each of the plurality of nodes are configured to monitor a portion of the geographical region such that the plurality of nodes are capable of capturing image data from the entire geographical region;
at least one drone comprising a transponder unit, where the transponder unit can transmit drone data to any of the plurality of cameras; and wherein each of the plurality of cameras is configured to receive the drone data and combine the drone data with a visual image of the drone within the geographical region to determine a correct flight path for the drone within the network of nodes; and wherein each of the plurality of cameras is configured to transmit a new set of flight control data to the drone such that the drone can alter course as needed based on the new set of flight control data.

2. The mesh network of claim 1, wherein each of the plurality of cameras is a 5G enabled camera.

3. The mesh network of claim 1, wherein each of the nodes contains at least one camera.

4. The mesh network of claim 1, wherein each of the plurality of nodes contains more than one camera.

5. The mesh network of claim 4, wherein at least one of the more than one camera is an infrared camera.

6. The mesh network of claim 1, further comprising a supervisory control system wherein the drone data is transmitted from the network of nodes to the supervisory control system for monitor.

7. The mesh network of claim 6, wherein the supervisory control system is a human based system.

8. The mesh network of claim 1, wherein the drone is a VTOL drone.

9. The mesh network of claim 1, wherein the drone is a fixed wing drone.

10. The mesh network of claim 1, wherein the drone is a hybrid between fixed wing and rotary wing drone.

11. A method for controlling a drone comprising:
Obtaining a drone for operational control within a specific environment;
Obtaining a network of cameras positioned within the specific environment such that the network of cameras is positioned to maintain a continuous visual image of the drone within the specific environment;
Transmitting a set of drone data to the network of cameras;
Combining the set of drone data and the continuous visual image of the drone to determine an appropriate flight path for the drone within the specific environment; and
Adjusting the appropriate flight path for the drone based on the combination of drone data and visual image of the drone.

12. The method of claim 11, wherein the specific environment is an urban environment.

13. The method of claim 11, wherein the continuous visual image of the drone is maintained by overlapping areas of interest between each of the cameras within the network of cameras.

14. The method of claim 11, wherein adjusting the flight path for the drone comprises altering the flight path to avoid an obstruction selected from a group consisting of weather, building, construction, emergencies, and traffic.

15. The method of claim 11, wherein each of the cameras in the network of cameras is a 5G enabled camera.

16. The method of claim 11, further comprising a plurality of drones.

17. The method of claim 11, wherein the drone comprises a transponder for communication with and between the network of cameras.

18. The method of claim 11, wherein the drone is selected from a group consisting of VTOL, fixed wing, rotary wing, and a hybrid between fixed wing and rotary wing.

19. The method of claim 11, further comprising the step of monitoring the drone through a redundant supervisory system.

20. The method of claim 19, wherein the redundant supervisory system is human based.
